(19) United States
(12) Patent Application Publication
(10) Pub. No.: US 2023/0372861 A1
(43) Pub. Date: Nov. 23, 2023

(54) CARBON CAPTURE APPARATUS, METHOD, AND CAPTURE ELEMENT

(71) Applicant: Nishant Lahiri, Corning, NY (US)

(72) Inventor: Nishant Lahiri, Corning, NY (US)

(21) Appl. No.: 18/128,467

(22) Filed: Mar. 30, 2023

Related U.S. Application Data
(60) Provisional application No. 63/339,775, filed on May 9, 2022.

(51) Int. Cl. B01D 53/04

(52) U.S. Cl. CPC B01D 53/0438; B01D 53/0446; B01D 2253/202; B01D 2253/25; B01D 2257/504; B01D 2258/06; B01D 2259/4508

(57) ABSTRACT

A carbon capture apparatus is disclosed that includes one or more fabric substrates in housing. The substrates are treated with a sorbent that absorbs an atmospheric gas, such as carbon dioxide, at ambient temperature. The sorbent may be an amine such as polyethyleneimine. The housing is positioned in a building where CO₂ is generated, such as a home or office. The housing may be connected with an air handling system such as an HVAC system to deliver air including a higher level of CO₂ to the carbon capture apparatus. The treated substrate is allowed to absorb CO₂. Periodically, the substrate is removed from the building and treated to desorb CO₂. The desorbed CO₂ is collected for industrial use or is reacted with a mineral slurry and disposed of.

This application claims priority under 35 U.S.C. § 119 to U.S. Provisional Pat. Appl. No. 63/339,775, filed May 9, 2022, the disclosure of which is incorporated herein by reference.

### BACKGROUND OF THE INVENTION

### 1. Field of the Invention

The present disclosure relates to an apparatus and a method of carbon capture. More particularly, the present disclosure relates to an enhanced carbon dioxide capture element that may be used with such an apparatus and method.

### 2. Description of the Related Art

Carbon dioxide is estimated to comprise 76% of all greenhouse gasses. Unless CO₂ levels are managed, its atmospheric heat-trapping characteristics are expected to cause a catastrophic 2.5° C.-4.5° C. (4.5° F. to 8° F.) rise in temperature by the year 2100. Anthropogenic carbon dioxide emission is the main contributor to the observed ˜110 ppm rise in CO₂ concentration from pre-industrial levels (NOAA, 2013).

Supplementing the transition away from fossil fuels to low-carbon energy sources with carbon capture and storage (CCS) is a potential approach for the mitigation of CO₂ emissions. CCS uses a combination of technologies to capture CO₂ and transport it to a safe and permanent storage location. Various industrial-scale CO₂ capture technologies have been developed or are in research. For example, industrial-scale direct-air carbon dioxide capture plants move large volumes of ambient air through scrubber mechanisms that adsorb CO₂ which can then be sequestered in underground formations. In some cases, large-scale carbon capture devices are coupled with facilities such as fossil fuel power plants to capture CO₂ from the gases emitted by combustion. Such centralized systems are not suitable for directly capturing CO₂ emitted by individuals, or groups of individuals.

Various carbon capture apparatuses and processes have been proposed, including U.S. Patent Application Publication 20210370230, which describes a method for enhancing a sorbent membrane for carbon dioxide capture; U.S. Patent Application Publication 20210340078, which describes electrolysis and carbon dioxide capture in a suitable solvent; U.S. Patent Application Publication 20210260527, which describes a substrate with a carbon dioxide capture coating composition that may comprise a coating material and a photosynthetic organism; U.S. Patent Application Publication 20210060483, which describes a hollow membrane unit having an inner conduit composed of a vapor membrane, and an outer conduit having an inside surface circumscribing the inner conduit forming a lumen; U.S. Patent Application Publication 20200129930, which describes a carbon dioxide capture unit that has a layer comprising solid porous material; U.S. Patent Application Publication 20130098246, which describes a polymer membrane used in carbon dioxide capture equipment for capturing carbon dioxide from the exhaust gas of a boiler; and U.S. Patent Application Publication 20160074831, which describes compositions of various sorbents based on aerogels of various silanes and their use as sorbent for carbon dioxide, all of which are incorporated herein by reference.

Known CO₂ capture techniques do not address the need to capture CO₂ where it is generated by individuals, families, and coworkers, in offices, homes, and neighborhoods. CCS technologies currently under development focus on emissions from large point sources such as coal or natural gas-fired power plants and cement industries. Indoor, residential, and hyper-local CO₂ capture has not been seriously considered.

### BRIEF SUMMARY OF THE INVENTION

Described are a system, apparatus, method, and means for carbon capture using a treated substrate. According to an embodiment, a carbon capture apparatus includes a fabric substrate adapted to absorb an atmospheric gas at ambient temperature in a housing containing the fabric substrate. The carbon capture apparatus may also include an air handler providing a flow of air to the capture apparatus to increase the kinetics of carbon dioxide capture. For example, the air handler may include one or more fans or other air flow-controlling means that provide a substantially fixed rate of airflow to the substrate.

According to another embodiment, an atmospheric gas processing system and apparatus include a degassing chamber designed to receive the fabric substrate. In an embodiment, the degassing chamber includes a temperature control causing the received fabric substrate to be at a second temperature substantially greater than ambient temperature at which the atmospheric gas desorbs from the fabric substrate. The desorbed gas may be captured and used for industrial or agricultural purposes, e.g., to create fertilizer. Alternatively, the desorbed gas flows through an aqueous sequestration apparatus connected to the degassing chamber. The sequestration apparatus includes a liquid absorbent, wherein the atmospheric gas desorbed from the fabric substrate dissolves in the absorbent. A slurry-forming apparatus may be in fluid communication with the sequestration apparatus to receive the liquid absorbent. A material that reacts with the desorbed gas may be provided as a slurry mixed with liquid absorbent. The reactive material may include a mineral substrate, wherein the liquid absorbent is mixed with the mineral substrate to form a slurry, and wherein the atmospheric gas absorbed in the liquid absorbent reacts with the mineral substrate to form a solid over time.

In such an atmospheric gas processing system and apparatus, according to an embodiment, the atmospheric gas is carbon dioxide.

In such an atmospheric gas processing system and apparatus, according to an embodiment, the fabric substrate is first treated with a carbon sequestering agent. The sequestering agent may be a chemical that reversibly binds carbon dioxide. The fabric substrate may be a high surface area material.

In such an atmospheric gas processing system and apparatus, according to an embodiment, the carbon sequestering agent may be a sorbent selected from one or more of metal hydroxides such as sodium hydroxide or calcium hydroxide. According to another embodiment, the carbon sequestering agent may be an amine-functionalized silica. According to another embodiment, the carbon sequestering agent is a monomeric or polymeric amine such as monoethanolamine (MEA) or diethanolamine (DEA), a silylated amine such as 3-aminopropyltriethoxysilane, poly (L-lysine), or a combination thereof. According to a preferred embodiment, the carbon sequestering agent is polyethyleneimine (PEI).

In such a carbon capture apparatus, the fabric may be made of a polyester fabric, a polyethylene fabric, a polypropylene fabric, a polyolefin fabric, a cotton fabric, a polyethylene silica aerogel composite fabric, a cellulosic aerogel, a ceramic wool, or a combination of two or more of the foregoing.

In such an apparatus, according to an embodiment, the fabric substrate is made of cotton or may be comprised mostly of cotton, or nearly entirely of cotton. According to another embodiment, the fabric comprises polyester or cotton, or a combination thereof.

In such an apparatus, according to an embodiment, the fabric substrate has a specific surface area from approximately 0.5 m2/g to approximately 200 m2/g, as measured, for example, by BET/nitrogen surface area measurement. According to one embodiment, the specific surface area of the fabric substrate is greater than 1 m2/g.

According to an embodiment, the fabric substrate is configured in an arrangement in the housing to facilitate contact between ambient air flowing through the apparatus and the substrate. For example, the fabric substrate may be in one or more configurations: pleated, folded, rolled, or stacked. Such compact arrangements may increase the surface area of the fabric substrate so as to optimize the usable inside volume of the housing of the apparatus.

In such an apparatus, according to an embodiment, the fabric substrate is folded into specific patterns such as Miura Ori folds.

According to one embodiment, the fabric substrate is disposed on rolls that facilitate transporting the substrate through an air stream including carbon dioxide. The rolls may be motorized to transport fabric through the apparatus to facilitate contact between the air and reactive moieties on the substrate.

According to an embodiment, such an apparatus is configured to be deployed indoors and has a compact profile suitable for use in a residence and is adapted to be replaceable. In one embodiment, the housing holding the substrate can be conveniently removed to a carbon capture facility and replaced with a new housing including a new substrate. According to one embodiment, the housing includes wheels to facilitate the movement of the housing. According to another embodiment, the housing is fixed, for example, by being attached to a heating, ventilating, or air conditioning (HVAC) system and the fabric substrate is removable from the housing for transportation to a carbon processing and desorption facility.

### BRIEF DESCRIPTION OF THE DRAWINGS

The above-provided aspects and/or other aspects of the disclosure will be more apparent based on the detailed exemplary embodiments of the disclosure with reference to the accompanying drawings, in which:

FIG. 1 is a view of a CO₂ capture unit, according to an illustrative example of the present disclosure connected with an air handler system.

FIG. 2 is a view of a CO₂ capture unit according to an alternative embodiment of the disclosure.

FIG. 3 illustrates a method of capturing and then recycling and/or sequestering CO₂ according to an embodiment of the disclosure.

FIG. 4 illustrates a chemical reaction for capturing CO₂ according to an embodiment of the disclosure.

FIG. 5 is a schematic showing an illustrative process and an apparatus for creating and using a substrate for testing CO₂ capture according to an embodiment of the disclosure.

FIG. 6 is a chart that compares CO₂ captured by three substrates according to embodiments of the disclosure in ambient conditions and pure CO₂ atmosphere conditions.

FIG. 7 is a chart of testing data comparing CO₂ capture and other properties of the three substrates according to embodiments of the disclosure.

FIG. 8 shows substrate mass for the three substrates according to embodiments of the disclosure subjected to repeated cycles of CO₂ adsorption and desorption.

FIG. 9 shows measured ambient CO₂ levels in a closed container exposed to substrates according to embodiments of the disclosure over time.

FIG. 10A illustrates a substrate according to embodiments of the disclosure formed into a CO₂-absorbing element folded into a Miura Ori folded configuration.

FIG. 10B illustrates a Miura Ori creased tessellation pattern in an open, unfolded position.

### DETAILED DESCRIPTION OF EXEMPLARY EMBODIMENTS

Exemplary embodiments of the disclosure will now be described below by reference to the attached Figures. The described exemplary embodiments are intended to assist the understanding of the invention and are not intended to limit the scope of the invention in any way. Like reference numerals refer to like elements throughout.

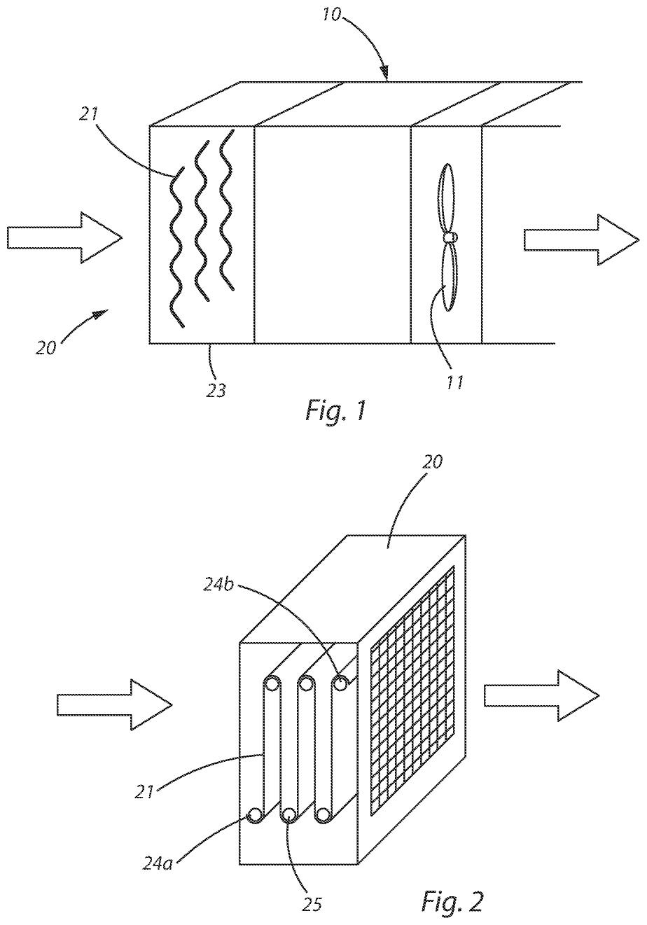

FIG. 1 shows a CO₂ capture unit 20, including a housing 23 and substrates 21 positioned in the housing 23. FIG. 1 illustrates, by way of example, rows of substrates 21 arranged in a pleated manner so as to increase the surface area of the substrates 21 that are positioned in the machine. Also, FIG. 1 illustrates several rows of substrates positioned in the housing 23.

According to one embodiment, one or more air-directing devices 11, for example, fans, are provided at or in the CO₂ capture unit 20 to increase the rate of airflow to the substrates. This may increase the amount of CO₂ captured per unit of time by increasing the amount of ambient airflow to inner facing surfaces of the substrates 21 and to substrates positioned as inside rows. The air-directing device 11 may be a part of an air conditioner system 10, such as the air handler of an HVAC system. The CO₂ capture unit 20 is integrated with or provided adjacent to an HVAC system or outlet/inlet so that the CO₂ capture unit 20, while provided as a passive airflow system, is provided with forced air through the parallel sheets of substrate 21 inside the CO₂ capture unit 20. Thus, inefficiencies due to the local depletion of CO₂ may be mitigated and an increased rate of CO₂ capture overall may be provided by the CO₂ capture unit 20 without the need for additional fans for the CO₂ capture unit 20 itself. According to another embodiment, CO₂ capture unit 20 is a passive capture system relying on natural air flows to expose the substrates 21 to ambient CO₂. This may save energy and prolong the useful life of the substrate.

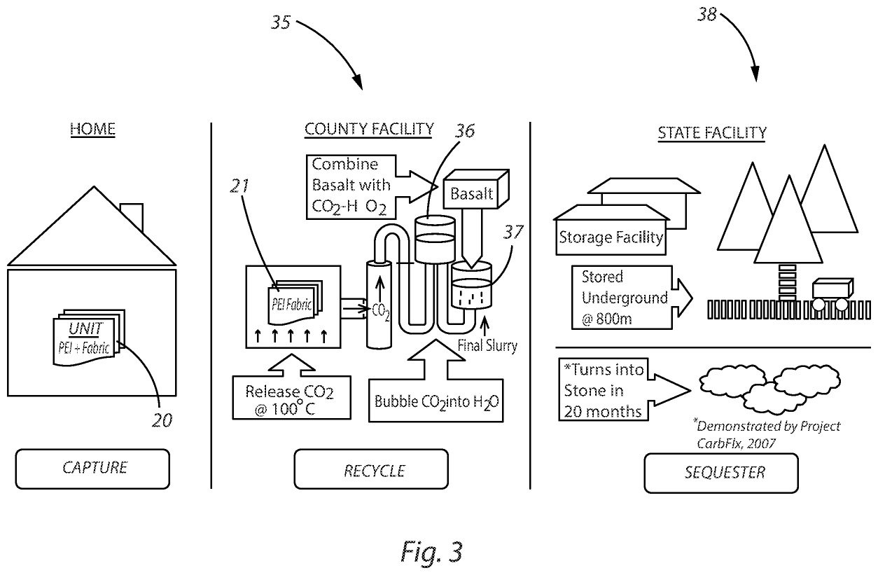

FIG. 2 shows another embodiment of CO₂ capture unit 20. In this embodiment substrate 21 is disposed on a series of rollers 25. A source roll 24a holds a length of the substrate. The substrate passes along rollers 25 to a take-up roll 24b. Take-up roll 24b may be motorized to allow a constant or intermittent motion of the substrate through unit 20. A plurality of rolls 25 may be provided so that a plurality of portions of the substrate 21 are extended across the path where air flows through the unit.

Substrates 21 may be formed by a fabric including one or more sorbents that reversibly sequester CO₂. According to embodiments of the disclosure high-efficiency sorbents that have a low to moderate cost are provided on substrate 21. Sorbents for direct air capture (DAC) can be solid or liquid and can be based on physisorption or chemisorption. Adsorbents or absorbents include activated carbon, silica, alumina, mesoporous carbon, zeolites, metal-organic frameworks (MOFs), microporous carbon, polymers, metal hydroxides such as Na or Ca hydroxides, and the like. According to some embodiments, sorbents include monomeric and polymeric amines such as monoethanolamine (MEA) or diethanolamine (DEA), silylated amines such as 3-aminopropyltriethoxysilane, poly (L-lysine), polyethyleneimine silane, polyethyleneimine (PEI), and the like. According to one embodiment, the carbon dioxide sequestering agent is a branched polyethyleneimine or polyethyleneimine silane with a molecular weight >5,000.

Amine-based sorbents on solid substrates may be preferred due to their lower energy penalty in regeneration compared to conventional aqueous amine scrubbing technology. According to one embodiment, polyethyleneimine may be preferred because it is easily synthesized, relatively inexpensive, and more thermostable relative to monomeric amines such as MEA or DEA. Desirable attributes for such adsorbents include high absorption rates, thermal stability, cyclic capacity, and low cost.

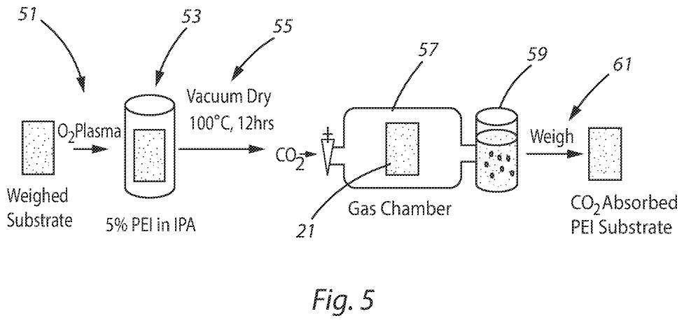

Illustrative embodiments of the disclosure using PEI are provided. Embodiments within the scope of the disclosure are not limited to PEI sorbents and include other moieties that react with gasses such as CO₂ to releasably fix molecules of the gas and allow the gas to later be desorbed. FIG. 4 illustrates that the chemistry of capture using PEI is based on the initial formation of carbamates (43 of FIG. 4) that can further convert to carbamic acid and/or bicarbonates (45 of FIG. 4).

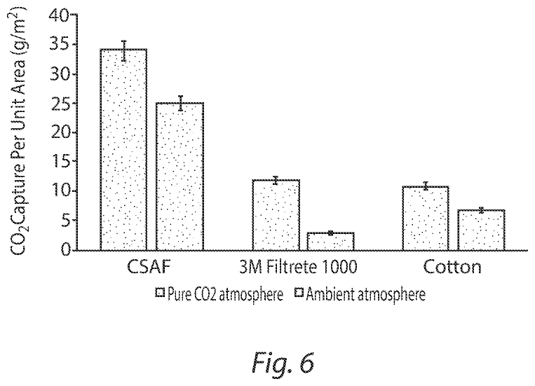

According to an embodiment, prior to being positioned in the CO₂ capture unit 20, the substrates are treated with a CO₂ adsorbing agent. As shown in FIG. 5, according to an embodiment, fabric substrates are placed in an Oxygen Plasma Machine (Plasma Etch), as shown in Step 51 of FIG. 5, for example, for five minutes, to thoroughly clean the fabric. Polyethyleneimine (PEI; MW 70,000; N, available from Upstate Scientific) is dissolved in a suitable solvent, for example, isopropyl alcohol (IPA) to form a solution, as shown at step 53 of FIG. 5. According to one embodiment, the solution includes between about 1% and 30% PEI. According to a preferred embodiment, the solution contains about 5% PEI in IPA. The substrate is then submerged in the solution to saturate the fabric substrate with the solution. According to one embodiment, the substrate is immersed in the solution for a duration of approximately 1 minute to one hour. According to a preferred embodiment, the substrate is immersed in the solution for about eight minutes. Following PEI adsorption, soaked substrates are transferred into a heating apparatus, for example, into a vacuum oven, and heated at a temperature and duration suitable to evaporate the IPA (between about 85° C. and about 100° C. for about 1 hour to about 12 hours, as shown at step 55). It will be understood that one or more of the above-described treatment steps may be modified or omitted, or may be combined and performed as a single step. For example, the cleaning step may be modified or omitted. The application of PEI to the substrate may be performed in other ways, for example, with methods using solvents other than IPA.

The substrate including PEI is then used to adsorb and desorb CO₂. Steps 57, 59 and 61 in FIG. 5 illustrate, respectively, steps for testing absorption and desorption of CO₂ by the substrate 21. In step 57 the substrate 21 is exposed to carbon dioxide at a selected high partial pressure inside a chamber. Following absorption of CO₂, the substrate may be removed from the chamber and weighed in step 61 to determine the amount of CO₂ absorbed. The continuous flow of carbon dioxide through the chamber can be demonstrated by connecting the chamber to a bubbler, as shown in step 59.

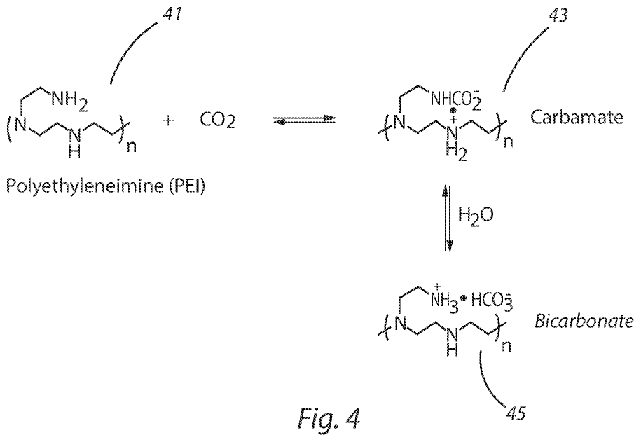

FIG. 3 illustrates the CO₂ capture unit 20 in the context of the recycling and sequestering process according to an embodiment of the disclosure. CO₂ capture unit 20 may be provided as a removable housing connected with the HVAC system of a home, factory, office building, or other similar settings as shown in FIG. 1. After suitably long exposure to ambient air including CO₂ as shown on the left-hand side of FIG. 3, the CO₂ adsorbed on the substrate 21 within housing 23 is removed and transported to a facility where CO₂ can be desorbed from the substrate and sold for industrial purposes or sequestered for long term storage or disposal. Once CO₂ has been desorbed from substrate 21, housing 23 including the regenerated substrate 21 may then be reused, for example, to replace another used carbon capture device 20. Used substrates 21 may be removed by an end user, such as a consumer using the CO₂ capture unit 20 in a dwelling or office, and taken to a local recycling facility, as shown in the center portion of FIG. 3. Alternatively, capture units 20 may be provided by a service vendor. Technicians employed by the service vendor visit locations where capture units 20 are installed and periodically remove and replace used capture units with regenerated units.

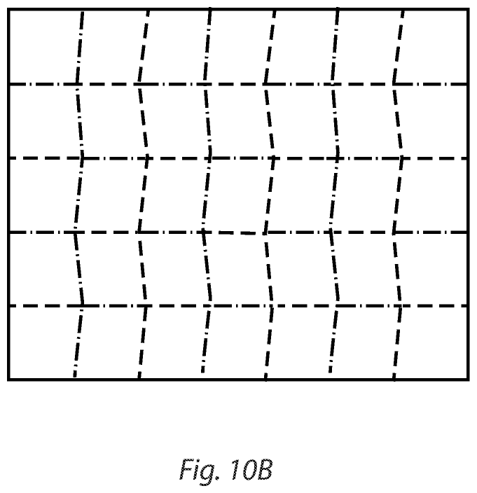

According to an embodiment, the substrate 21 with housing 23 may be arranged in a folding pattern to enable greater capture capacities in smaller footprints. According to one embodiment, the substrate may be pressed so that a Miura Ori crease pattern is formed as a tessellation of the substrate. Such creasing of the substrates to form a Miura pattern would yield a substrate of a matrix of parallelograms, as shown in FIG. 10B. In this way, the substrate may be conveniently folded without damage. It will be understood that various types of folding or pleating may be used to pretreat the substrates. A number of types of rigid origami, folding of a flat sheet, are also contemplated. FIG. 10A shows a plurality of substrates 21 folded in a Miura Ori pattern and stacked to fit within housing 23.

As shown in FIG. 3, used capture units 21 are transported by end-users or technicians to a central facility to capture absorbed CO₂ and regenerate the units. At the central facility 35, the substrate 21 is treated to desorb the captured CO₂. According to one embodiment, the substrate 21 is heated to between about 50° C. and about 150° C., to between about 85° C. and about 120° C., or to about 100° C. for a period of time sufficient to desorb the captured CO₂. A purge gas may be provided to the chamber to transport the desorbed CO₂ from the chamber. According to one embodiment the substrate is treated with a low-pressure steam purge gas that provides both a thermal and concentration driving force to desorb CO₂. According to another embodiment, heat applied to desorb gas from substrate 21 is collected from a source of waste heat from an industrial process. The CO₂ thus released may have commercial applications, for example, in the fertilizer or beverage industry.

According to another embodiment, the released CO₂ may then be bubbled into water in a water tank 36 to dissolve the CO₂ in the water. The water may be combined with metal oxide-bearing minerals, such as basalt, a natural, abundant rock, and/or other minerals to form a slurry in a mixing tank 37. The CO₂ reacts with the mineral, to form a solid, for example, by forming carbonates. The slurry may be transported to a regional facility 38 for permanent sequestration, for example, by injecting the slurry underground (˜800 meters). According to another embodiment, instead of forming a mineral slurry, the water including dissolved CO₂ is injected into a rock formation containing metal oxide bearing minerals where reaction between the CO₂ and the rock formation sequesters the CO₂ by lithification.

Table 1, below, shows properties of preferred substrates 21.

TABLE 1

| Substrate | | Indoor | Recycling |
|---|---|---|---|
| Properties | Chemistry | Usability | Requirements |
| High Surface | High CO₂ | Non- | Desorption at |
| Area for PEI | Absorption | shedding | Low |
| Adsorption | | | Temperatures |
| Pleat-able/Roll- | Chemical | Mechanically | Long Term |
| able/Stack-able | Stability | Strong | Re-usability |
| Optimal Moisture | Optimal Capture | Lightweight | Low Trans- |
| Absorption | Kinetics | | portation Costs |
| Thermal Stability | Thermal Stability | Small | Low Cost |
| up to 100° C. | up to 100° C. | Footprint | Processing |

Fabric substrate 21 may be made of a variety of materials having various characteristics relevant to embodiments of the disclosure. Such fabric substrates may include, but are not limited to:
(i) Commercially available air filter materials used in HVAC systems. According to an embodiment, substrates 21 may be 3M Filtrete 1000, 3M Filtrete 1500, or the like.
(ii) Textiles including nylon and polyester, and cotton. Nylon and polyester, as synthetic fabrics, have the potential of being chemically tailored to the needs of the CO₂ capture and release process.
(iii) Mineral wool, such as ceramic wool. As a thermally and highly stable material commonly used in insulation, ceramic wool would be expected to offer excellent corrosion resistance and lifetime.
(iv) Polyester polyethylene composite silica aerogel fabric (CSAF). CSAF, though significantly more expensive relative to the other substrates, offers the potential for a very high surface area.
(v) A cellulosic aerogel. Cellulosic aerogels have high specific surface area (10-975 m2/g) and may have greater mechanical strength compared with silica aerogels and synthetic polymer aerogels. In addition, precursor materials for cellulosic aerogels may be less toxic than those of synthetic polymer aerogels and may be derived from biological sources, which may reduce the amount of atmospheric carbon created to form the fabric. In addition, cellulosic aerogels may be more easily biodegraded compared with synthetic polymer-based materials.
(vi) According to an embodiment, the substrate is made substantially or entirely of cotton, or of primarily cotton together with a minority of other fibers. Cotton is a natural fabric, and the growth of cotton may be a net-negative process. According to one embodiment, cotton used to form the substrate 21 is grown using a “no-till” technique. An acre of no-till cotton stores about 350 pounds more of atmospheric carbon than it emits during production.

As summarized in Table 2, below, fabric substrate materials may have a range of specific surface areas. The surface area of the CSAF material is approximately 236.01 m2/g, which is significantly greater than the other substrates tested. Ceramic wool material showed the second-highest surface area at ˜3.02 m2/g of the materials above-noted. Cotton has the third-highest surface area ˜1.28 m2/g, which is two orders of magnitude lower than CSAF. Polyester (˜0.09 m2/g) and nylon (0.08 m2/g) textiles had significantly lower surface areas. The Filtrete materials also showed a low surface area of ˜0.06-0.07 m2/g. The Brunauer-Emmett-Teller (BET) method was used for surface area measurements. The fabric substrate may also be formed from a cellulosic aerogel. Specific surface areas for aerogels derived from cellulose may be between about 10 m2/g and about 975 m2/g. According to embodiments of the disclosure, substrate 21 has a specific surface area of between about 0.05 m2/g to about 1000 m2/g, or a specific surface area of greater than 1 m2/g.

TABLE 2

| | BET Specific |
|---|---|
| Substrate | Surface Area (m²/g) |
| CSAF | 236.0132 |
| Ceramic wool | 3.0212 |
| Cotton | 1.2841 |
| Polyester | 0.0912 |
| Nylon | 0.0824 |
| 3M Filtrete 1000 | 0.0722 |
| 3M Filtrete 1500 | 0.0672 |
| Dust Sheet | 0.0652 |

Samples of various substrate materials were treated with a PEI/isopropyl alcohol mixture and dried, as discussed above. The amounts of PEI bound to three such substrates varied. Table 3, below, summarizes the amounts of PEI bound to substrates of various types:

TABLE 3

| | Amount of PEI captured |
|---|---|
| Substrate | (±0.01 g/m²) |
| CSAF | 166.01 |
| 3M Filtrete 1000 | 20.10 |
| Cotton | 3.64 |

As shown in Table 3, much more PEI was taken up by CSAF than by cotton or other materials noted above.

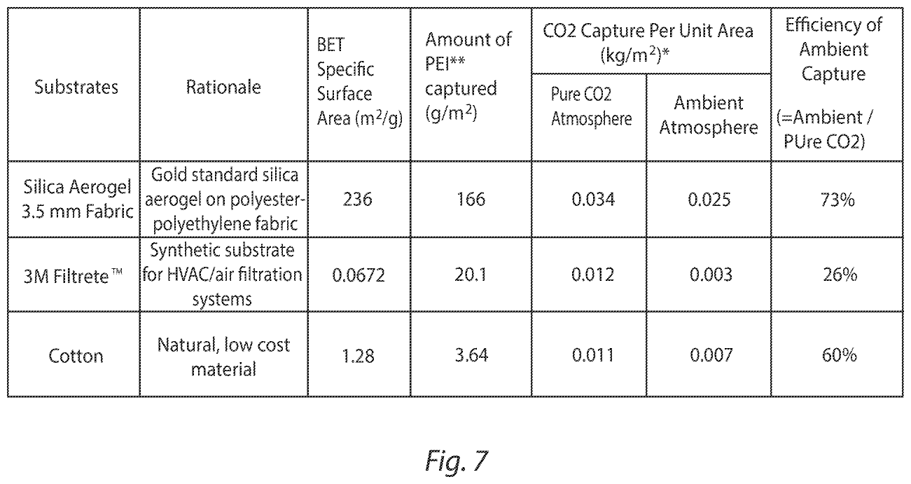

Substrates made of different materials when tested demonstrated advantages and disadvantages relative to one another. According to one embodiment, CSAF, 3M Filterete, and cotton substrates were treated with a PEI/isopropyl alcohol solution, as described above. After drying, these substrates were tested using the apparatus shown in FIG. 5. Chamber 57 was supplied with either a pure CO₂ gas or with ambient air. The resulting capture of CO₂ is shown in FIG. 6.

CO₂ capture was shown by all three substrates. Under ambient CO₂ conditions, both CSAF (25 g-CO₂/m2) and cotton (12 g-CO₂/m2) showed significant CO₂ capture, while 3M Filtrete 1000 showed lower capture (3 g-CO₂/m2), as shown in FIG. 6. The low CO₂ capture value for 3M Filtrete 1000 may be attributed to its tightly woven fibers not allowing proper diffusion of air throughout the adsorbent. There may also be a reduction in efficiency due to excess PEI hindering access to amino groups on themselves when bound to the adsorbent.

According to embodiments of the disclosure, in addition to selecting the material forming the substrate 21, the porosity of the substrate is selected to facilitate airflow through the substrate to enhance the absorption of CO₂.

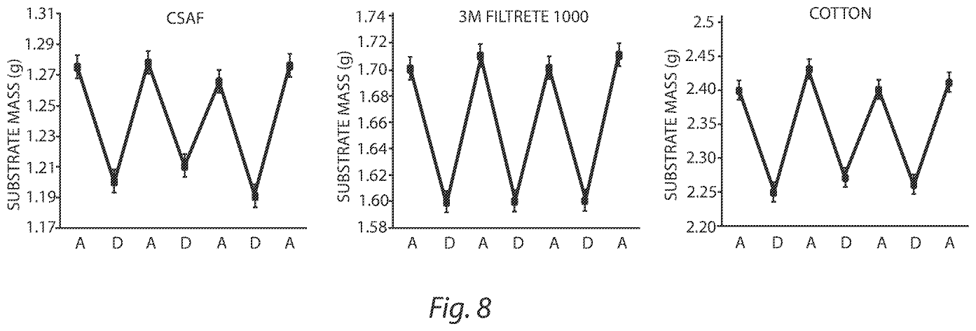

A surprising finding is the high ambient CO₂ capture by cotton substrate, given the low loading of the PEI material on the cotton fabric during the substrate pre-treatment phase. FIG. 7 summarizes the parameters of three of the types of substrates that could be used in embodiments of the disclosure. Surprisingly, while cotton substrate has a much lower surface area per unit of mass than does CSAF, and has a much lower PEI retention rate per unit of mass, cotton has a CO₂ ambient CO₂ passive capture efficiency rate of 60%, an efficiency rate that almost approaches that of CSAF at 73%.

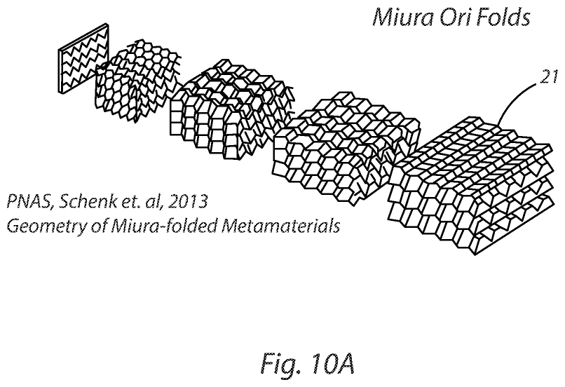

The ability for selected substrates 21 to absorb CO₂ under ambient conditions is shown in FIG. 9. According to one embodiment, treated CSAF and cotton substrates prepared as described above were placed in a 12″×12″×12″ chamber under ambient conditions. A 10,000 ppm K-30 nondispersive infrared (NDIR) CO₂ sensor (co2 meter.com) was used with gas lab 2.3.1 software for CO₂ level monitoring. The chamber was equipped with a door to add substrates to the enclosure. The sensor was placed in the box with the cord passing through a drilled and sealed hole in the box. Data collection was begun five minutes before placing PEI-impregnated substrates to obtain a stable baseline. Substrates were introduced immediately after removal from the vacuum oven (step 55 in FIG. 5) and the sensor was set to collect data every 10 seconds for a total of 65 minutes including baseline calibration.

FIG. 9 shows the concentration of CO₂ in the chamber over time. The baseline CO₂ starting value was stabilized for five minutes prior to introducing the PEI-impregnated adsorbent and is indicated by the ppm value at time t=0. The arrow indicates the time of PEI adsorbed substrate insertion. There was a decrease in CO₂ levels immediately for both PEI-loaded CSAF and cotton substrates. CSAF demonstrated an approximately 50% higher capture relative to cotton.

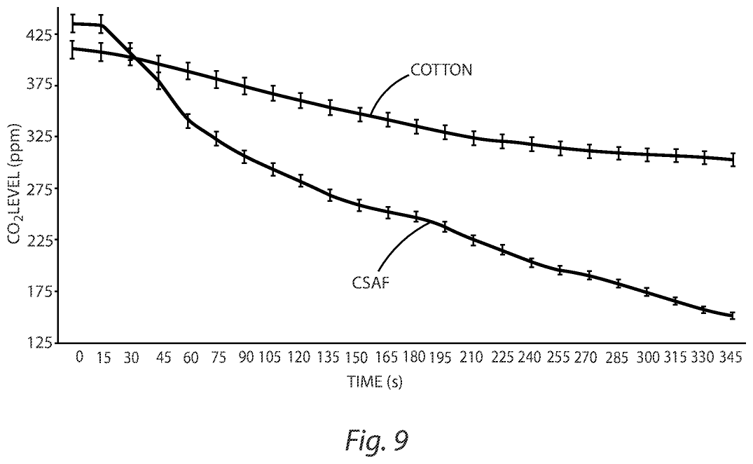

According to one embodiment, recyclability was demonstrated for regeneration of the substrates made of CSAF, 3M Filtrete, and cotton, as shown in FIG. 8. FIG. 8 shows the change in mass of substrates subjected to repeated cycles of CO₂ absorption and desorption. Each of the three substrates tested, CSAF, 3M Filterete, and cotton, the substrates were subjected to pure CO₂ for 4 hours at 20° C. (points “A” along the bottom axis) and then to 85° C. for 3 hours (points “D” along the bottom axis).

During the CO₂ removal phase, the substrates are heated significantly, for example to about 85° C. to 100° C. In the recyclability testing shown in FIG. 8, no visible browning on CSAF, cotton, or 3M Filtrete 1000 was observed. However, CSAF dried considerably after heating. The silica aerogel beads suspended in the polyester polyethylene fiber mesh disintegrated during handling.

While cotton has a much lower surface area (1.28 m2/g) relative to CSAF (236 m2/g) and a significantly lower PEI loading (3.64 g/m2) relative to CSAF (166 g/m2), surprisingly the efficiencies of ambient air capture, the ratio of CO₂ capture under ambient to pure CO₂ atmospheres, are comparable; 60% for cotton and 73% for CSAF after 24 hours. Moreover, cotton enables much more conservative use of PEI: 3.022 g CO₂ per 1 g-PEI, compared to 0.205 g-CO₂ per 1 g-PEI for CSAF. The conservation of the active capture agent PEI in conjunction with inexpensive and robust textile substrates would improve capture/cost ratios for cotton. The PEI-impregnated cotton fabric is a highly efficient sorbent capturing ˜3.1 mmol-CO₂/g-substrate based on its capture capacity (˜250 mmol/m2) and weight (˜81 g/m2). In fact, this capacity is significantly higher (29%) than currently reported values of 1.7-2.4 mmol/g. In addition, cotton production, under some circumstances, is a carbon-negative process. Thus, according to some embodiments of the disclosure, a carbon dioxide capture unit 20 that includes substrates 21 including cotton has favorable carbon dioxide characteristics and with favorable properties in terms of the low expense and low carbon footprint of their production, and with good recyclability.

According to another embodiment, the fabric substrate 21 is formed partially or entirely from a cellulosic material such as a cellulosic aerogel. Cellulosic aerogels may be derived from biological sources including cotton, may generate fewer CO₂ emissions when created compared with synthetic polymer materials, and may be biodegradable. According to one embodiment, fabric substrate 21 is formed from a cellulosic aerogel with a specific surface area between about 10 m2/g to about 1000 m2/g. The fabric substrate is treated with one or more sorbents, as discussed in the previous embodiments.

According to one embodiment, CO₂ is captured where it is generated—in factories, homes, and neighborhoods. A three-stage CCS process is provided that is compatible with community-based initiatives for carbon management as shown in FIG. 3. A subscriber with a sequestration unit such as unit 20 captures CO₂ directly from the air, either passively or as a result of providing a stream of ambient air via an HVAC system. The capture unit is brought curbside for pickup. The substrates from multiple households may be picked up and taken to a central facility 35 to be heated to release the CO₂. The released CO₂ may be sold (for example, to the fertilizer industry) or taken down the path of permanent sequestration by bubbling into water 36 and combining with basalt 36, a naturally forming and abundant volcanic rock. For the latter, the slurry may then be pumped underground at a regional facility 38 (˜800 meters) to transform into rock through the process of lithification.

Carbon capture efficiencies for the embodiment of the disclosure including CO₂ capture at locations such as homes and offices using substrates 21 can be significant. It has been reported that the energy required for the desorption of CO₂ is about 1740 MJ/MT-CO₂. The production of 1 GJ energy from natural gas releases 55.82 kg-CO₂. Thus, the desorption CO₂ emissions of 1 MT captured would offset the net CO₂ capture potential by about 97 kg-CO₂ (9.7%). This number is expected to be reduced with the further implementation of clean energy alternatives.

According to one embodiment, substrate 21 is transported to the local facility by a vehicle, such as a side loader garbage truck. Emissions associated with transportation are an important consideration in the efficiency of CO₂ capture. For example, a heavy-duty diesel vehicle (side loader garbage truck) that reaches 1500 homes/day emits 8 MTCO₂/yr while idling (940 hr), and 42 MTCO₂/yr while driving (14,000 km/yr; based on 52 weeks, 5 days/week, 7 hr/day). A truck used full-time to deliver capture units offsets the CO₂ captured (˜16,100 MT) (1500*260*41.25 kg/cycle) in the communities it serves by only 50MT-CO₂ or ˜0.3%.

For sequestration, the energy needed to inject concentrated CO₂ into a geological formation (for displacing water in its pore space), is approximately 2 kJ/mol-CO₂. This energy penalty correlates to 2.5 kg-CO₂ released for the capture of 1 MT-CO₂ (0.25% offset). With consideration of all given factors, the CO₂ capture potential of embodiments within the scope of the disclosure is decreased by ˜10.3% resulting in a net CO₂ capture potential of ˜1.89 MT-CO₂/year.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims. Therefore, the description should not be construed as limiting the scope of the invention.

What is claimed is:

1. A carbon capture apparatus comprising:
a fabric substrate adapted to absorb a carbon dioxide gas at an ambient temperature;
a housing containing the fabric substrate and adapted to expose the substrate to an atmosphere,
wherein a concentration of the carbon dioxide gas is lower concentration after exposure to the substrate than prior to exposure to the substrate.

2. A carbon capture system comprising the carbon capture apparatus according to claim 1, further comprising:
a degassing chamber adapted to receive the fabric substrate, wherein the degassing chamber comprises:
a temperature control causing the received fabric substrate to be at a second temperature higher than the ambient temperature, wherein the carbon dioxide gas desorbs from the fabric substrate at the second temperature;
and where the desorbed carbon dioxide is repurposed, sold, or permanently sequestered into a rock-forming slurry.

3. The apparatus according to claim 1, wherein the carbon capture apparatus is removably connected with an air handler, wherein the air handler forces air through the housing.

4. The apparatus according to claim 1, wherein the fabric substrate comprises a fabric and a carbon sequestering agent.

5. The system of claim 4, wherein the fabric substrate comprises one or more of a polyester fabric, a polyethylene fabric, a polypropylene fabric, a polyolefin fabric, a cotton fabric, a polyethylene silica aerogel composite fabric, a cellulosic aerogel fabric, and combinations thereof.

6. The apparatus of claim 1 where the fabric substrate has a specific surface area from about 0.05 m²/g to about 1000 m²/g.

7. The apparatus of claim 1, wherein the fabric substrate has a specific surface area >1 m²/g.

8. The apparatus of claim 1, wherein the fabric substrate comprises one or more sorbent materials selected from activated carbon, alumina, mesoporous carbon, zeolites, metal-organic frameworks (MOFs), microporous carbon, polymers, metal hydroxides, an amine, monoethanolamine (MEA), diethanolamine (DEA), a silylated amine, 3-aminopropyltriethoxysilane, poly (L-lysine), and polyethyleneimine (PEI), and combinations thereof.

9. The apparatus of claim 8, wherein the sorbent material is a polymeric amine with a molecular weight greater than about 5,000.

10. The apparatus of claim 1, wherein the fabric substrate is adapted to be configured into a compact arrangement such as pleated, folded, rolled, or stacked.

11. The apparatus of claim 1, wherein the substrate comprises a plurality of portions of substrate sheets, the portions arranged substantially parallel to each other.

12. A system for distributed indoor carbon capture comprising:
an indoor carbon capture apparatus including a fabric substrate, the substrate adapted to absorb carbon dioxide at an ambient temperature;
a housing, the housing removably holding the fabric substrate and adapted to be delivered to a facility for desorption of the absorbed carbon dioxide.

13. The system according to claim 12, wherein the fabric substrate comprises a fabric and a carbon dioxide sequestering agent.

14. The system according to claim 12, wherein the fabric comprises one or more of a polyester fabric, a polyethylene fabric, a polypropylene fabric, a polyolefin fabric, a cotton fabric, and combinations thereof.

15. The system according to claim 12, wherein the fabric substrate is a composite material selected from cellulosic silica aerogel, a metal-organic framework material, and combinations thereof.

16. The system according to claim 13, wherein the carbon dioxide sequestering agent comprises a polymeric amine or polyethyleneimine.

17. The system according to claim 13, wherein the substrate is a cellulosic fabric and wherein the carbon dioxide sequestering agent is a branched polyethyleneimine or polyethyleneimine silane with molecular weight greater than about 5,000.

18. The system according to claim 13, wherein the fabric substrate and sequestering agent have an ambient absorption capacity in ambient air greater than about 50 percent of a pure absorption capacity in pure carbon dioxide.

19. The system according to claim 13, wherein the fabric substrate and sequestering agent have a carbon dioxide absorption capacity in ambient air greater than about 1.5 mmol/g of sorbent weight or greater than about 2.5 mmol/g of sorbent weight

20. A system for distributed indoor carbon capture for facilitating a carbon capture cycle comprising:
an indoor carbon capture apparatus including a fabric substrate, the substrate adapted to absorb carbon dioxide at an ambient temperature;
a housing, the housing holding the fabric substrate and adapted to be delivered curbside for pick-up to a facility for desorption of the absorbed carbon dioxide wherein the substrate after desorption is delivered back to the carbon capture apparatus to repeat the carbon capture cycle.
